(19) United States
(12) Patent Application Publication
(10) Pub. No.: US 2008/0282780 A1
(43) Pub. Date: Nov. 20, 2008

(54) Sire Flow Detector

(76) Inventor: Dario Kriz, Hoor (SE)

Correspondence Address: BUCHANAN, INGERSOLL & ROONEY PC, POST OFFICE BOX 1404, ALEXANDRIA, VA, 22313-1404, US

(21) Appl. No.: 11/629,974

(22) PCT Filed: Jun. 15, 2005
(86) PCT No.: PCT/SE2005/000911

§ 371 Date: Jan. 24, 2007

(30) Foreign Application Priority Data
Jul. 8, 2004 (SE) 0401814-9

(51) Int. Cl. G01N 30/00; G01N 25/00

(52) U.S. Cl. 73/61.57; 73/61.46; 977/958

(57) ABSTRACT

The present invention concerns a device and a method for the rapid detection of a low molecular substance in a liquid flow.

### TECHNICAL FIELD

The present invention assigns to a device for fast detection of low-molecular substances in a liquid flow from a micro-dialysis probe, filter unit, fermenter, cell suspension, chemical reactor, human being, tissue or animal and for dosing, regulation and control of pharmaceuticals, alternatively in vivo substances, exemplified but not limited to insulin or metabolites, and chemical or biological processes in fermenters, cell suspensions or chemical reactors.

### TECHNICAL BACKGROUND

The annual world market for liquid chromatography has from the beginning of the 1960s until today grown extensively. The market leaders in this area are companies like Pharmacia & Upjohn AB, Applied Biosystems Inc, Bioanalytical Systems, Hitatchi Instruments and Waters Corporation.

In parallel with this development, tools such as micro-dialysis probes have been produced for in vivo monitoring of patients and animals. Companies that are acting in this area include CMA Microdialys AB (Sweden) and SpectRx Inc (USA).

A third area involving monitoring and control of chemical processes and fermenters is under development. Companies that are active in this area are e.g. Applikon (NL), YSI Inc (USA) and Trace Biotech Ag (Germany). The latter company has developed a micro-dialysis like device for sampling from a fermentor under sterile conditions.

The common point in the mentioned three areas is that they are all dependent on detection systems, which preferentially are of the type of a flow-through detector. Using different types of flow-through detectors several important chemical substances can be identified and quantified. Depending on the physical measuring principle, different types of detectors have to be used to solve different kind of problems. Several detectors have been presented, in certain cases with excellent results. When metabolites such as glucose, lactate, and acetate are to be detected, biosensors have been used. Due to instability of biosensors the measuring performance demands have not been fulfilled.

Since 1995 a new type of biosensor technology, the SIRE Biosensor, has been developed, which is based on the injection of recognition elements [SE 510 733 (1999), U.S. Pat. No. 6,214,206 (2001) & U.S. Pat. No. 6,706,160 (2004)]. This technology has solved many technological problems usually related to measuring of chemical substances. The present invention can rather be integrated with the mentioned technology since it can use injectable enzymes as reagents, but with the difference that it is based on a new technological construction, which solves problems, that arise in qualitative and quantitative measurements of chemical substances in liquid flows, in a new and unexpected way.

Until today no technical solutions have been presented that solve the majority of the problems that arise in the use of traditional flow-through detectors for determination of low-molecular substances (Mw<5 kDa), exemplified but not limited to glucose, lactate, ascorbate, maltose, galactose, urea, ethanol, methanol, hydrogen peroxide, ascorbic acid, lactose, maltose, malic acid, glutamate and sucrose.

Above said problems include the need for connection of the flow-through detector close to the point of sampling (so that shorter analysis times caused by transport of the sample and reduced amounts of sample flow can be achieved), specific measurements, fast measurements, be resistant to temperature effects (both the temperature of the surroundings and the liquid flow), and to avoid manual handling of the sample.

The flow-through detector described in this application, offers a new and unique analysis of mentioned low-molecular substances. The present invention is a powerful solution that solves different kinds of problems that arise in liquid flow measurements in a completely new way. The major advantages with the present invention are: that metabolically active low-molecular substances can be determined qualitatively and quantitatively, that the invention can be connected in close proximity to the point of sampling and that it is not sensitive to fluctuations in the temperature affecting the result, which is usually very common during such measurements.

Different types of flow-through detectors for identification of chemical substances have been described. Different kinds of physical measuring principles have been used, exemplified by optical absorbance measurements (GB 2089062), fluorescence measurements (Takeuchi T. and Miwa T. Anal. Chim. Acta 311, 231-236, 1995), Raman spectroscopic measurments (Cabalin L. M. et. al. Talanta 40, 1741-1747, 1993), FTIR spectrophotometry (Hellgeth J. W. and Taylor L. T. Anal. Chem. 59, 295-300, 1987), photo-acoustic measurements (Voigtman E. et. al. Anal. Chem. 53, 1921-1923, 1981), electro-luminiscense measurements (Hill E. et. al. J. Chromatography 370, 427-437, 1986), radioactivity measurements (De Korte D. et. al. J. Chromatography 415, 383-387, 1987) and electro-chemical measurements (Sagar K. A. Talanta 42, 235-242, 1995). These are based on other types of construction and have not been able to solve the above mentioned problems.

Earlier, a device for determination of enzymatic activity in a sample has been reported [JP 2-208551 (1990)]. However, enzymes are high-molecular substances with a molecular weight that is usually larger than 5 kDa and their ability to pass through a semi-permeable membrane is reduced. The mentioned report describes a flow-through detector that lacks the main component, the semi-permeable membrane that exists in the present invention described in this application. Moreover, temperature sensor, heating-/cooling elements are not present.

### SUMMARY OF THE INVENTION

The present invention is a device, characterised by that it consists of a minimum of two flow-through chambers separated by a semi-permeable membrane (perforated by nano-pores of a size ranging from 0.1 to 900 nm), a detector, a temperature sensor, one or more connections for electrical cables, where the one of the flow-through chambers that contains the detector has an inlet and an outlet for liquid flows with enzymatic reagents, and that each of the other flow-through chambers have an inlet and an outlet for liquid flow from the point of sampling.

The invention also refers to a method where a device according to the invention is used for real-time and/or close to real-time detection of low-molecular chemical substances in a liquid flow.

The invention also refers to a method where a device according to the invention is especially used as a flow-through detector in liquid chromatography (e.g. capillary LC, HPLC, FPLC, Affinity Chromatography and Gel Filtration), and for detection of low-molecular substances from a micro-dialysis probe, filter unit, fermenter, cell suspension, chemical reactor, human being, tissue or animal and for dosing, regulation and control of pharmaceuticals, alternatively in vivo substances, exemplified but not limited to insulin or metabolites, and chemical or biological processes in fermenters, cell suspensions, chemical reactors or tissues.

### SHORT DESCRIPTION OF DRAWINGS

FIG. 1 shows a principal schedule of the device according to the present invention. The liquid flow containing the low-molecular substance to be detected is guided through inlet A to flow-through chamber B where the mentioned substance can diffuse through the nano-pores of the semi-permeable membrane G to flow-through chamber E, alternatively join the liquid flow that are guided through outlet C from flow-through chamber B. When the mentioned substances are in flow-through chamber E, they are able to chemically react with enzymatic reagents that have been introduced in the chamber through inlet D. Products from the enzymatic reaction diffuses to the detector H and gives rise to an electrical signal that correlates quantitatively to the amount of mentioned low-molecular substance in the liquid flow introduced through inlet A. Incoming liquid, enzymes, non-reacted low-molecular substance and reaction products leave flow-through chamber E trough outlet F. The inlets and outlets can be reversed so that flows with opposite directions are achieved. The detector H can also be used for detection of a background signal referring to the earlier mentioned SIRE Biosensor principle. The detector H can also contain a temperature sensor and/or a heat-generating/cooling element.

### DETAILED DESCRIPTION OF THE INVENTION

According to one aspect of the invention the device is characterised by that the flow-through chambers each have a chamber volume in the interval 0.1 to 5000 μl.

According to another aspect of the invention the device is characterised by that it consists of a three-electrode system, a working electrode made of Platinum, a reference electrode made of Silver and a counter electrode made of Platinum or Silver.

According to another aspect of the invention the device is characterised by that the working electrode has a potential that is +200 to +1000 mV above the reference electrode potential.

According to another aspect of the invention the device is characterised by that it is equipped with a temperature sensing element, exemplified but not limited to Pt100, Pt1000, DS1820, LM35 or KTY 81-120, for temperature compensation of the measurements.

According to another aspect of the invention the device is characterised by that it is equipped with a heat-generating/cooling source, exemplified but not limited to a resistor or a Peltier element for thermostating of the device to a constant temperature in the interval 5 to 80 degrees Celsius.

According to another aspect of the invention the device is characterised by that the mentioned semi-permeable membrane is made of, exemplified but not limited to cellulose acetate, Nafion, ceramic material, metalurgic material and polymeric material with a molecular cut-off in the interval from 0.1 kDa to 500 kDa.

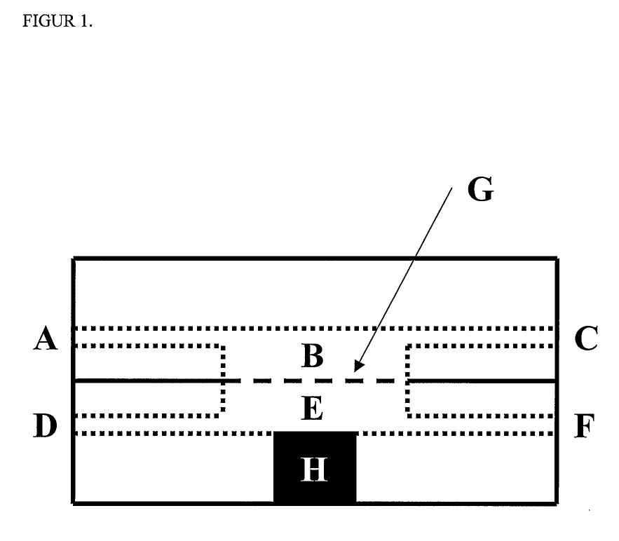

According to one aspect the measuring principle is based on the so called SIRE Biosensor technology mentioned earlier in this patent application. FIG. 1 shows a principal schedule over the present invention. The liquid flow containing the low-molecular substance to be detected is guided through inlet A to flow-through chamber B where the mentioned substance can diffuse through the nano-pores in the semi-permeable membrane G to flow-through chamber E, alternatively be transported through the liquid flow guided through the outlet C from flow-through chamber B. When the mentioned substances are in flow-through chamber E, they are able to react chemically with enzymatic reagents introduced by a liquid flow through inlet D. Reaction products from the enzymatic reaction diffuses to the detector H and give rise to an electrical signal that correlates quantitatively with the amount of low-molecular substance in the liquid flow introduced through inlet A. Incoming liquid, enzymes non-reacted low-molecular substance, and reaction products leaves flow-through chamber E through outlet F.

The inlets and outlets can be re-directed so that flows that run in opposite directions are achieved. The detector can also be used for detection of a background signal according to the earlier mentioned SIRE Biosensor principle. The detector can also contain a temperature sensor and/or heat-generating/cooling element.

Examples of low-molecular substances that are present in liquid flows from a micro-dialysis probe, fermenter, cell suspension, chemical reactor, human being, tissue or animal are extensively described in the patent literature.

Traditional flow-through cells based on e.g. visible/UV light or conductivity are not able to qualitative or quantitative determination of the great majority of low-molecular substances that are present in liquid flows from a micro-dialysis probe, fermenter, cell suspension, chemical reactor, human being, tissue or animal.

The present invention circumvents this problem since the specificity and the enzymatic ability of the used reagents feed the detector with enough amount of chemical signal substance, as for example hydrogen peroxide formed by oxidases, to qualitatively be able to determine the amount of mentioned low-molecular substance.

1. A biosensor device, containing a semi-permeable membrane with nano-pores having an average cross-section in the range of 0.1 to 900 nm, where said membrane separates two flow-through chambers, where the first of the flow-through chambers contains a detector of the amperometric type and an inlet and an outlet for a liquid flow containing enzymatic reagents, and where the second flow-through chamber has an inlet and an outlet for a liquid flow containing chemical substances for qualitative and/or quantitative detection.

2. A device according to claim 1, wherein said device is also equipped with a temperature sensor for temperature compensation of the measurements.

3. A device according to claim 2, wherein said temperature sensor is of the type Pt100, Pt1000, DS1820, LM35, or KTY 81-120.

4. A device according to claim 1, wherein the device is equipped with a heat-generating or cooling element for controlling the temperature of the device at a constant temperature within the range of 5 to 80 degrees Celsius.

5. A device according to claim 1, wherein said detector consists of a working electrode made of platinum, a reference electrode made of silver, and a counter electrode made of platinum.

6. A device according to claim 1, wherein said working electrode has a potential that is +200 to +1000 mV above the reference electrode potential.

7. A device according to claim 1, wherein both the above mentioned flow-through chambers each have a chamber volume within the range of 0.1 to 5000 μl.

8. A device according to claim 1, wherein said semi-permeable membrane consists of cellulose acetate, Nafion, ceramic material, metallurgic material or polymeric material with a limitation of the permeability of high-molecular substances, exemplified but not limited to enzymes, proteins, cells, cell components, and polymers.

9. A method where the device according to claim 1 is used for qualitative and/or quantitative determination of low-molecular (Mw<5 kDa) substances in a liquid flow from a micro-dialysis probe, fermenter, cell suspension, chemical reactor, human being, tissue or animal.

10. A method where the device according to claim 1 is used for optimisation, control, or regulation of chemical or biological processes in fermenters, cell suspensions or chemical reactors.

11. A device according to claim 2, wherein the device is equipped with a heat-generating or cooling element for controlling the temperature of the device at a constant temperature within the range of 5 to 80 degrees Celsius.

12. A device according to claim 3, wherein the device is equipped with a heat-generating or cooling element for controlling the temperature of the device at a constant temperature within the range of 5 to 80 degrees Celsius.

13. A device according to claim 2, wherein said detector consists of a working electrode made of platinum, a reference electrode made of silver, and a counter electrode made of platinum.

14. A device according to claim 3, wherein said detector consists of a working electrode made of platinum, a reference electrode made of silver, and a counter electrode made of platinum.

15. A device according to claim 4, wherein said detector consists of a working electrode made of platinum, a reference electrode made of silver, and a counter electrode made of platinum.

16. A device according to claim 2, wherein said working electrode has a potential that is +200 to +1000 mV above the mentioned reference electrode potential.

17. A device according to claim 2, wherein both the above mentioned flow-through chambers each have a chamber volume within the range of 0.1 to 5000 μl.

18. A device according to claim 1, wherein said semi-permeable membrane consists of cellulose acetate, Nafion, ceramic material, metallurgic material or polymeric material with a limitation of the permeability of high-molecular substances, exemplified but not limited to enzymes, proteins, cells, cell components, and polymers.

19. A method where the device according to claim 2 is used for qualitative and/or quantitative determination of low-molecular (Mw<5 kDa) substances in a liquid flow from a micro-dialysis probe, fermenter, cell suspension, chemical reactor, human being, tissue or animal.

20. A method where the device according to claim 2 is used for optimisation, control, or regulation of chemical or biological processes in fermenters, cell suspensions or chemical reactors.
